(19) United States
(12) Patent Application Publication
(10) Pub. No.: US 2015/0051997 A1
(43) Pub. Date: Feb. 19, 2015

(54) DYNAMIC PRICING SYSTEM AND METHOD

(71) Applicant: SiteScout Inc., Toronto (CA)

(72) Inventors: Theodore TAOUSSANOPOULOS, Toronto (CA); Paul MOKBEL, Toronto (CA)

(21) Appl. No.: 14/458,573

(22) Filed: Aug. 13, 2014

Related U.S. Application Data
(60) Provisional application No. 61/865,403, filed on Aug. 13, 2013.

(51) Int. Cl. G06Q 30/08

(52) U.S. Cl. CPC G06Q 30/08
USPC 705/26.3

(57) ABSTRACT

Dynamic pricing can be used in, for example, second price auctions for internet advertising. A safety margin is subtracted from a bid to generate a modified bid. Upon notice that the modified bid is successful, a total margin is determined The total margin is a difference between the modified bid and a winning bid. Use of dynamic pricing enables an advertiser to win more often than if a fixed margin greater than the safety margin is used.

### CROSS-REFERENCE TO RELATED APPLICATIONS

This application claims priority to the provisional patent application titled “Dynamic Pricing System and Method,” filed Aug. 13, 2013 and assigned U.S. App. No. 61/865,403, the disclosure of which is hereby incorporated by reference.

### FIELD OF THE INVENTION

The invention relates to a dynamic pricing system and method. The invention, more particularly, relates to a dynamic method for pricing internet advertising in a second-price auction environment and a system for performing this dynamic method.

### BACKGROUND OF THE INVENTION

Internet advertising delivers promotional marketing to consumers. Internet display advertising is one particular example of internet advertising. Internet display advertising may include, for example, web banner ads, frame ads, pop-up ads, pop-under ads, floating ads, expanding ads, trick banners, interstitial ads, rich media ads, video ads, or text ads. Display ads may be served on desktop or laptop computers, mobile devices, or internet-connected appliances (such as televisions). Internet advertising revenue in general, and display advertising revenue in particular, is growing significantly each year.

Ad exchanges are technology platforms that facilitate bidding for the buying and selling of internet advertising from multiple ad networks, demand side platforms (called DSPs) and agency trading desks. These ad exchanges create a marketplace for demand sources to purchase display advertising, auctioning off each available spot for ads (called an impression) as it becomes available.

One common method for an internet advertising auction is for the advertiser to submit a bid through a bidding service provider (which may be an ad network, a DSP or an agency trading desk), which then passes a modified bid to an ad exchange minus the bidding service provider's margin. For example, the advertiser may authorize a maximum of $1.00 to purchase an impression. The bidding service provider reserves or allocates a 25% profit margin of $0.25 and then places a bid of $0.75 (i.e., $1.00 minus the $0.25 profit margin) on behalf of the advertiser with the ad exchange Despite the advertiser's maximum bid of $1.00, if any other bidding service provider submits a bid greater than $0.75, then the advertiser bidding $1.00 will lose the auction, that advertiser's ad will not be served, and the bidding service provider acting on that advertiser's behalf will not receive any revenue. Considering that a bidding service provider incurs a fixed cost to bid on an impression (win or lose), an improved pricing method may allow for additional revenue. More particularly, a dynamic method for pricing internet advertising in a second-price auction environment is needed.

### BRIEF SUMMARY OF THE INVENTION

In a first embodiment, a method is provided. A bid is received from a first party via a web interface. A safety margin is subtracted from the bid to generate a modified bid. The modified bid is submitted to an auction facilitator. A total margin is determined upon notice that the modified bid is successful. The total margin is a sum of the safety margin and a difference between the modified bid and a winning bid. The bid may be for an internet advertisement sold using a second price auction. The safety margin may be set. This safety margin also may be fixed or may be a minimum value for the total margin. The total margin may be capped at a maximum value prior to determining the total margin.

In a second embodiment, a method is provided. A bid is transmitted from a first party to a bidding system. A safety margin is subtracted from the bid to generate a modified bid using the bidding system. The modified bid is submitted to an ad exchange using the bidding system. A total margin is determined using the bidding system upon notice that the modified bid is successful. The total margin is a sum of the safety margin and a difference between the modified bid and a winning bid. The bid may be for an internet advertisement sold using a second price auction. The safety margin may be set. This safety margin also may be fixed or may be a minimum value for the total margin. The total margin may be capped at a maximum value prior to determining the total margin.

In a third embodiment, a system is provided. The system has a web interface, a modified bid calculator, a modified bid transmission system, and a total margin generator. The web interface is configured to receive a bid from a first party. The modified bid calculator is connected to the web interface and subtracts a safety margin from the bid to generate a modified bid. The modified bid transmission system is connected to the modified bid calculator, forwards the modified bid to an ad exchange. and receives notice from the ad exchange that the modified bid was successful. The total margin generator is connected to the modified bid transmission system and generates a total margin upon the notice. The total margin is a sum of the safety margin and a difference between the modified bid and a winning bid. The total margin generator may be configured to cap the total margin at a maximum value.

In a fourth embodiment, a bidding system is provided. The bidding system has a storage medium, a communications interface, and a processor. The communications interface is configured to receive a bid from a first party. The processor is configured to subtract a safety margin from the bid to generate a modified bid, forward the modified bid to an ad exchange, receive notice from the ad exchange that the modified bid was successful, and generate a total margin upon the notice. The total margin is a sum of the safety margin and a difference between the modified bid and a winning bid.

### DESCRIPTION OF THE DRAWINGS

For a fuller understanding of the nature and objects of the invention, reference should be made to the following detailed description taken in conjunction with the drawings, in which:

FIG. 1 is a flowchart illustrating a first embodiment of a dynamic pricing method;

FIG. 2 is a table providing some examples of winning bids using this total margin and an exemplary total margin cap;

FIG. 3 is a table providing examples with and without dynamic pricing; and

FIG. 4 is a system diagram for a system that can perform dynamic pricing.

### DETAILED DESCRIPTION OF THE INVENTION

While the embodiments are described herein with respect to internet advertising, one skilled in the art will recognize that the embodiments described herein also can be applied to other situations or other environments. For example, these embodiments can be applied to other second price auctions where bidding costs (irrespective of winning or losing the auction) are fixed. Thus, the dynamic pricing method disclosed herein can be applied outside of internet advertising.

In an embodiment, the previous fixed margin is eliminated. Instead, a “safety” margin is used and a “total” margin is calculated based in part on this safety margin, the advertiser's maximum price, and the price at which the auction is won. The safety margin provides a minimum commission the bidding service provider is willing to accept and may cover, for example, costs related to bidding and/or marginal costs associated with winning the auction (e.g., accounting/invoicing, performance tracking, etc.). The safety margin may be determined such that the bidding service provider breaks-even on the transaction, makes a profit on the transaction, or otherwise, as determined by the provider.

The total margin provides for the maximum margin available to the bidding service provider in a given situation, which may be capped. This total margin may include or encompass the safety margin, and may be equal to or larger than the safety margin. When calculated in this manner, the total margin, or the bidding service provider's commission for facilitating the bid, maximizes profitability by maximizing the number of winning bids and the margin taken on each winning bid. Dynamic pricing with a safety margin and a total margin enables a bidding service provider to win bids it would otherwise lose, even though the profit margin on some incremental winning bids may be lower. Since the cost of bidding may be the same in all situations, it may still be in the bidding service provider's interest to capture lower-margin, incremental wins.

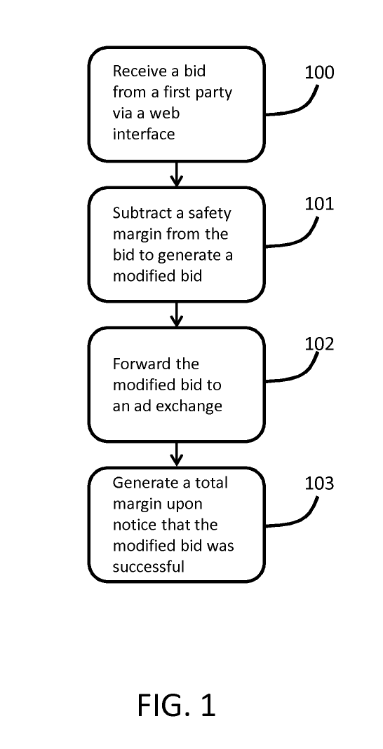

FIG. 1 is a flowchart illustrating a first embodiment of a dynamic pricing method. In step 100, the bidding service provider receives a bid from a first party via a web interface. The first party may be an advertiser, a bidder, a customer, or a user of the bidding service provider's system or services. While the bid is illustrated as being received via a web interface, this bid also could be received via telephone, fax, mail, other messaging systems, or a face-to-face interaction. In step 101, the bidding service provider subtracts a safety margin from the bid to generate a modified bid. As described above, the safety margin may be determined by the bidding service provider based on its business requirements (e.g., to cover marginal costs, to generate a small profit over costs, etc.) In step 102, the bidding service provider forwards, submits, or passes on the modified bid to an auction facilitator, such as an ad exchange or another provider. If the modified bid is successful or wins the ad auction, then in step 103 the bidding service provider generates a total margin. The total margin includes the safety margin, plus the difference between the modified bid and a winning bid (which may be capped so as not to generate too high of a total margin).

In a first example, the advertiser provides the bidding service provider with instructions to bid up o a maximum of $1.00. The bidding service provider reserves or allocates a 10% safety margin, and passes on a $0.90 modified bid on the advertiser's behalf to the ad exchange. If the ad exchange receives a bid higher than $0.90, the advertiser does not win the auction and pays nothing to the bidding service provider. If, however, the advertiser's $0.90 bid is the highest received by the ad exchange, the advertiser wins the auction and the total margin is determined In this first example, if the second highest bid for the impression was $0.84, then the advertiser will win the auction held by the ad exchange at $0.85. The total margin is then determined by taking the safety margin (i.e., $0.10) and adding to it the difference between the modified bid price ($0.90) and the winning bid price ($0.85). Since the difference between the modified bid price and winning bid price is $0.05, then the total margin is $0.15 (i.e., $0.10 safety margin plus $0.05 difference) or 15%. This 15% includes the 10% safety margin plus an additional 5% (representing the difference between the $0.90 modified bid and the $0.85 winning bid). Thus, the bidding service provider maximizes its revenue by winning bids it would otherwise lose, and the advertiser wins more often than it would if the bidding service provider took a fixed margin greater than the safety margin.

In one particular embodiment, the total margin is capped. For example, the total margin may be capped at a particular percentage, such as 25%. The bidding service provider may select the cap of the total margin in order to provide a suitable profit while remaining competitive with other providers or based on other factor(s).

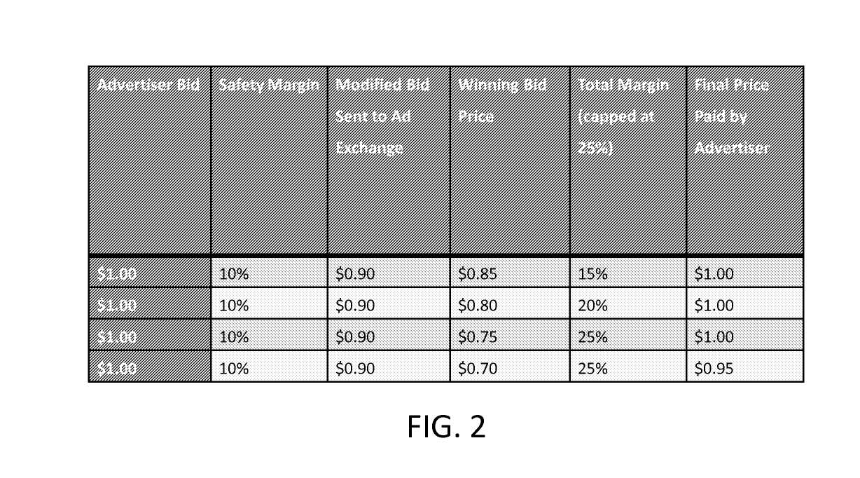

FIG. 2 illustrates a table providing some examples of winning bids using this total margin and an exemplary 25% total margin cap. The modified bid sent to the ad exchange may represent a maximum modified bid authorized by the advertiser. The actual bid or bids passed on to the ad exchange may start or remain lower than the maximum modified bid authorized by the advertiser.

Thus, with a 25% cap on a total margin, if the advertiser's bid minus the winning bid provides greater than or equal to the 25% total margin, then the price actually paid by the advertiser will be set such that the total margin is only 25%. With the same 25% cap on total margin, if the advertiser's bid minus the winning bid is less than the 25% total margin, then the total margin is the safety margin plus the difference between the modified bid price and the winning bid price.

With a capped total margin, the advertiser may pay less than its bid. With a 25% margin cap, if the advertiser bids $1.00 and the winning bid is $0.70, then the advertiser will only pay $0.95 (i.e., $0.70 winning bid plus $0.25 to pay bidding service provider's capped total margin).

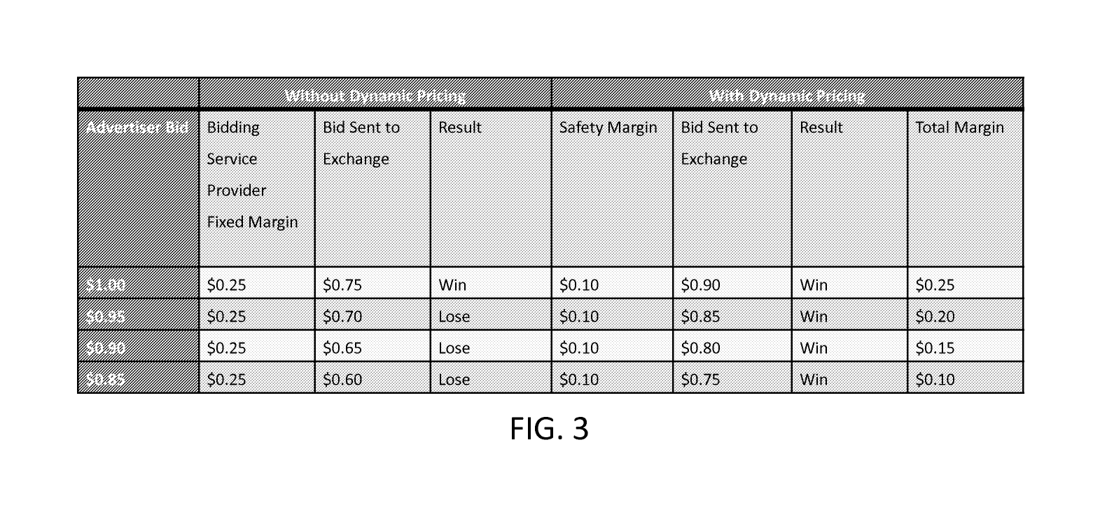

The value of using a dynamic pricing method in a second price auction is illustrated by comparing example auctions with and without the method. FIG. 3 is a table providing examples with and without dynamic pricing as disclosed herein. In this example, the advertiser is bidding a maximum of $1.00, and the next highest bid on the ad exchange is $0.74. For simplicity of illustration, the margin is set as $0.25 rather than as a percentage of the bid price. The result in each case, however, would be the same: the advertiser is more likely to win the auction when the bidding service provider utilizes dynamic pricing.

In the example illustrated in FIG. 3, the advertiser is never paying more than the maximum amount bid. However, when the bidding service provider utilizes dynamic pricing rather than charging a fixed margin, the advertiser wins auctions it would otherwise lose (e.g., when the advertiser bids $0.95, $0.90 or $0.85). Thus, the advertiser wins more auctions and the bidding service provider generates revenue on auctions it otherwise would not generate any revenue on. In the examples of FIG. 3, the advertiser wins four auctions using the dynamic pricing technique instead of one auction without dynamic pricing, and the bidding service provider generates $3.70 in total revenue instead of $1.00 and $0.70 in total margin instead of $0.25.

A system may be used to implement an embodiment of this dynamic pricing method. The system includes a web interface configured to receive a bid from a first party. A modified bid calculator subtracts a safety margin from the bid to determine a modified bid. A modified bid transmission system forwards or submits the modified bid to an ad exchange and receives notice from the ad exchange that the modified bid was successful or unsuccessful (i.e., whether the modified bid won or lost the ad auction). A total margin generator is configured to determine a total margin upon receiving notice from the ad exchange that the modified bid was successful. The total margin may include or encompass the safety margin and may include the difference between the advertiser's bid and the winning bid.

The advertiser's bid may be received via a web interface in one example. For example, a website or internet application may be used to receive the advertiser's bid. This website or internet application may be tied to a processor, software, or other system. The calculations and communications disclosed herein may be performed by a bidding system, which may include software and a communications interface. This bidding system may operate automatically without additional user interaction once an advertiser's bid is received.

The margin cap, safety margin, total margin, and advertiser bids can vary from those described herein. The examples listed herein are merely for illustrative purposes.

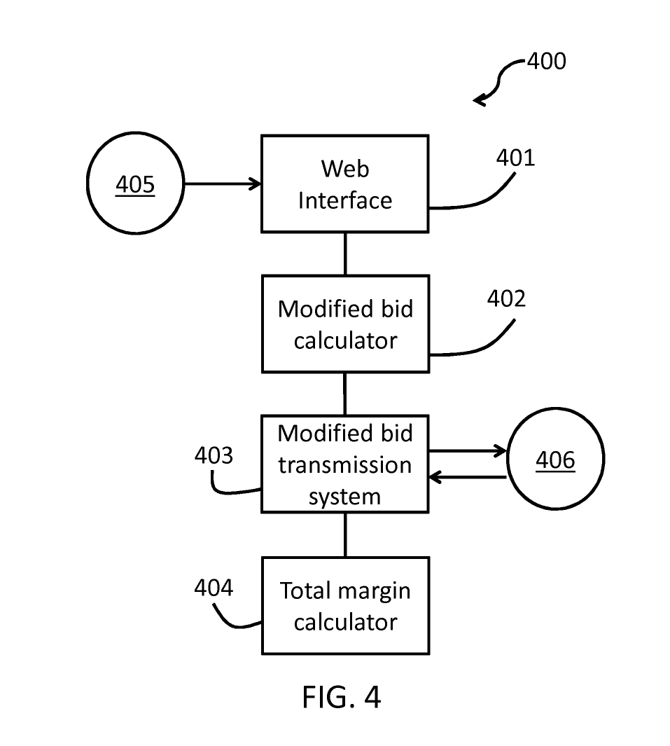

FIG. 4 is a system diagram for a system 400 that can perform dynamic pricing. The system 400 has a web interface 401, a modified bid calculator 402, a modified bid transmission system 403, and a total margin calculator 404. The web interface 401 receives a bid from a first party 405. The modified bid calculator 402 is connected to the web interface 401 and is configured to subtract a safety margin from the bid to generate a modified bid. The modified bid transmission system 403 is connected to the modified bid calculator 402 and forwards the modified bid to an ad exchange 406. The modified bid transmission system 403 also receives notice from the ad exchange 406 that the modified bid was successful. The total margin generator 404 is connected to the modified bid transmission system 403. The total margin generator 404 generates a total margin upon notice that the modified bid was successful. The total margin is a sum of the safety margin and a difference between the modified bid and a winning bid.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, wherein a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein. These examples are not exhaustive, and are for illustration and not limitation. Other variations known to those skilled in the art are possible.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method comprising:
receiving a bid from a first party via a web interface;
subtracting a safety margin from said bid to generate a modified bid;
submitting said modified bid to an auction facilitator; and
determining a total margin upon notice that said modified bid is successful, wherein said total margin comprises a sum of said safety margin and a difference between said modified bid and a winning bid.

2. The method of claim 1, wherein said bid is for an internet advertisement sold using a second price auction.

3. The method of claim 1, wherein said safety margin is fixed.

4. The method of claim 1, wherein said total margin is capped at a maximum value prior to said determining

5. The method of claim 1, wherein said safety margin is a minimum value for said total margin.

6. The method of claim 1, further comprising setting said safety margin.

7. A method comprising:
transmitting a bid from a first party to a bidding system;
subtracting a safety margin from said bid to generate a modified bid using said bidding system;
submitting said modified bid to an ad exchange using said bidding system; and
determining a total margin using said bidding system upon notice that said modified bid is successful, wherein said total margin comprises a sum of said safety margin and a difference between said modified bid and a winning bid.

8. The method of claim 7, wherein said bid is for an internet advertisement sold using a second price auction.

9. The method of claim 7, wherein said safety margin is fixed.

10. The method of claim 7, wherein said total margin is capped at a maximum value prior to said determining

11. The method of claim 7, wherein said safety margin is a minimum value for said total margin.

12. The method of claim 7, further comprising setting said safety margin.

13. A system comprising:
a web interface configured to receive a bid from a first party;
a modified bid calculator connected to said web interface that subtracts a safety margin from said bid to generate a modified bid;
a modified bid transmission system connected to said modified bid calculator that forwards said modified bid to an ad exchange and receives notice from said ad exchange that said modified bid was successful; and
a total margin generator connected to said modified bid transmission system that generates a total margin upon said notice, wherein said total margin comprises a sum of said safety margin and a difference between said modified bid and a winning bid.

14. The system of claim 13, wherein said total margin generator is configured to cap said total margin at a maximum value.

15. A bidding system comprising:
a storage medium;
a communications interface configured to receive a bid from a first party; and
a processor, wherein said processor is configured to subtract a safety margin from said bid to generate a modified bid, forward said modified bid to an ad exchange, receive notice from said ad exchange that said modified bid was successful, and generate a total margin upon said notice, wherein said total margin comprises a sum of said safety margin and a difference between said modified bid and a winning bid.
